(19) United States
(12) Patent Application Publication
(10) Pub. No.: US 2010/0319680 A1
(43) Pub. Date: Dec. 23, 2010

(54) Concentrating Solar Energy System for Multiple Uses

(75) Inventor: Edmund Joseph Kelly, San Jose, CA (US)

Correspondence Address: Edmund Kelly, 3251 Pinot Blanc Way, San Jose, CA, 95135, US

(73) Assignee: Edmund Joseph Kelly, San Jose, CA (US)

(21) Appl. No.: 12/488,852

(22) Filed: Jun. 22, 2009

(51) Int. Cl. F24J 2/38; B23P 15/26; F24J 2/30

(52) U.S. Cl. 126/601; 29/890.033; 126/643

(57) ABSTRACT

Systems and methods for concentrating solar energy in the high earth atmosphere and transmitting the concentrated solar energy to the earth's surface. A system includes a light weight solar concentrator, supported by a light weight, rigid, buoyant, structure (36). The buoyant structure is suspended high in the earth's atmosphere above clouds and weather. Steerable mirrors, and/or a steerable structure, enable the concentrator to track the sun. In one embodiment, a buoyant light pipe (20) enables the transmission of concentrated solar energy from the high altitude concentrator to the earth's surface for further use. The system provides concentrated solar energy for use at any location on the earth, such use including generation of electricity via thermal or photovoltaic means and, direct and indirect process heat. The uses of process heat include desalination and hydrogen or methanol or other fuel production. A high solar concentration ratio enables high temperature, and hence high efficiency heat engine operation. With the provision of a thermal storage unit a system can provide utility scale continuous electricity generation and process heat at any location on the planet.

### CROSS-REFERENCE TO RELATED APPLICATIONS

Non-provisional application Ser. No. 12/430,869, filed on Apr. 27, 2009.

### FEDERALLY SPONSORED RESEARCH

Not Applicable

### SEQUENCE LISTING OR PROGRAM

Not Applicable

### BACKGROUND

1. Field

This invention generally relates to solar energy systems, more particularly to, concentrating solar energy systems for power generation and process heat.

2. Prior Art

Concentrating Solar energy systems use optical components such as lenses and mirrors to collect and concentrate the sun's radiation and then absorb it for practical use. The main practical use is to provide high temperature working fluids to drive heat engines that in turn drive electricity generators. Other uses for concentrated sunlight include high intensity photovoltaic electricity generation, direct high temperature “clean” process heat, and indirect high temperature process heat.

A wide variety of designs have been developed to accomplish these goals. The following references provide a good overview of this technology.

“Solar Engineering of Thermal Processes” by John A Duffie and William A Beckman, chapter seven and “Solar Energy” by G. N. Tiwari, chapter eight.

All current concentrating solar energy designs include two major elements:
a) optical concentrators that accept and concentrate the incoming solar radiation
b) receivers that absorb the solar energy and heat a working fluid.

Concentrators can use some of the following structural arrangements:
a) single lenses with attached receivers as one moveable structure,
b) rigid arrays of lenses or arrays of lens segments with an attached receiver, all on a common moveable structure,
c) arrays of independently moving lenses on a stationary base (like the ground) with a central stationary receiver, such as heliostat arrays.

The lenses can use imaging optical elements and non-imaging optical elements. The lenses can use reflective optical elements and/or refractive optical elements. Regardless of their construction, concentrators are characterized by their entrance aperture and their exit aperture. In the case of multiple lens arrays or segments, the input aperture is the sum of the apertures of the elements of the array. The ratio of the area of the input aperture divided by the area of the exit aperture is the concentration ratio.

Receivers absorb the concentrated radiation from the concentrator and transfer this absorbed energy to a working fluid. This hot fluid is then either used to directly power a heat engine (such as a steam turbine), or is used to transfer heat via a heat exchanger to a second working fluid which is then used to power a heat engine. The heat engine then drives a generator which produces electricity. Some systems first transfer heat from the working fluid to thermal storage, and then from thermal storage to a second working fluid in order to decouple when electrical energy is generated from when solar energy input is captured by a receiver.

Some hypothetical space based systems have been proposed that generate electricity via these processes in space and then convert the electrical energy to microwave energy to be beamed to the earth's surface and collected via large microwave antennae arrays.

Another unrelated area of prior art is light pipes. Glass and plastic versions of these have long been used in the area of telecommunications to transmit low power light signals over long distances. Light pipes using hollow tubes with various highly reflective inner surfaces are used to guide sunlight or artificial light over short distances for lighting purposes within buildings. A particularly efficient method used for lighting is described in U.S. Pat. No. 4,260,220, “Prism light guide having surfaces which are in octature” issued to Lorne A. Whitehead on Apr. 7, 1981.

Another method used for lighting is described in U.S. Pat. No. 4,895,420, “High reflectance Light Guide” issued to John F. Waymouth on Jan. 23, 1990.

Light pipes are characterized by their aperture, acceptance angle, and attenuation. Light pipes accept light travelling in the direction of the light pipe within their acceptance angle. Generally light from point or small area concentrated light sources needs to pass through a collimator in order to satisfy the acceptance angle criteria and reduce attenuation. Collimators are common optical elements and are effectively the reverse of optical concentrators, with a smaller entrance aperture than larger exit aperture. As well as conditioning light for light pipes or guides, optical collimators are used for a variety of purposes. These include projector condenser lenses, parabolic reflector light bulbs, and telescope objective lenses.

Current Concentrating Solar systems suffer from several problems that have limited their success. Their high capital costs make the cost of the energy they produce uncompetitive without subsidy. They also have high ancillary costs to compensate for the unpredictability of their energy output and the long transmission distance from the system to the average power user.

Concentrating Solar systems make use of direct sunlight, i.e. light directly from the sun that is not scattered or absorbed in earth's atmosphere. Current systems are severely negatively affected by effects of weather such as rain, clouds, moisture and dust in the atmosphere. This restricts their geographical location to hot dry desert areas which are relatively scarce and far from consumers of electricity. In addition, even in deserts, bad weather sometimes restricts electric power output availability, necessitating the provision of alternate sources of supply.

Solar concentrators need to have large entry apertures to produce meaningful amounts of power. Utility scale systems have apertures measured in millions of square meters. Current systems consequently consume large areas of land and significant quantities of construction materials like glass and steel needed to fabricate this large aperture collector. Also weather in the form of dust, wind, rain, hail frost and snow require that structures be strong and durable which adds significantly to their cost.

Current large scale systems use large arrays of individually steered collecting elements. Robust motors, gears, electrical equipment etc are needed for each collector element, contributing significantly to overall cost.

The cost problem is compounded by the generally low overall energy conversion efficiency of current systems, which consequentially requires a larger surface area and more material to produce a given power output compared to higher conversion efficiency systems.

### SUMMARY

The present invention is realized by suspending a solar energy concentrator at a high altitude in the earth's atmosphere, above clouds, moisture, dust, and wind. This is accomplished using a light-weight, rigid, buoyant, structure. The concentrated solar energy output from the concentrator is then (optionally) collimated with a collimator and coupled to a light pipe. The solar energy is then transmitted through the light pipe to the earth's surface where it is (optionally) further concentrated in order to better achieve high temperatures. It is then coupled to a receiver which heats a working fluid, which in turn transfers heat for use in generating electricity and/or as process heat. There are many uses for this process heat. Examples include thermal desalination, thermally augmented hydrogen or methanol generation, along with a myriad of conventional chemical processes.

These and other objects and features of the invention will be better understood by reference to the detailed description which follows taken together with the drawings in which like elements are referred to by like designations throughout the several views.

### DRAWINGS

### Figures

In the drawings, closely related figures have the same number but different alphabetic suffixes.

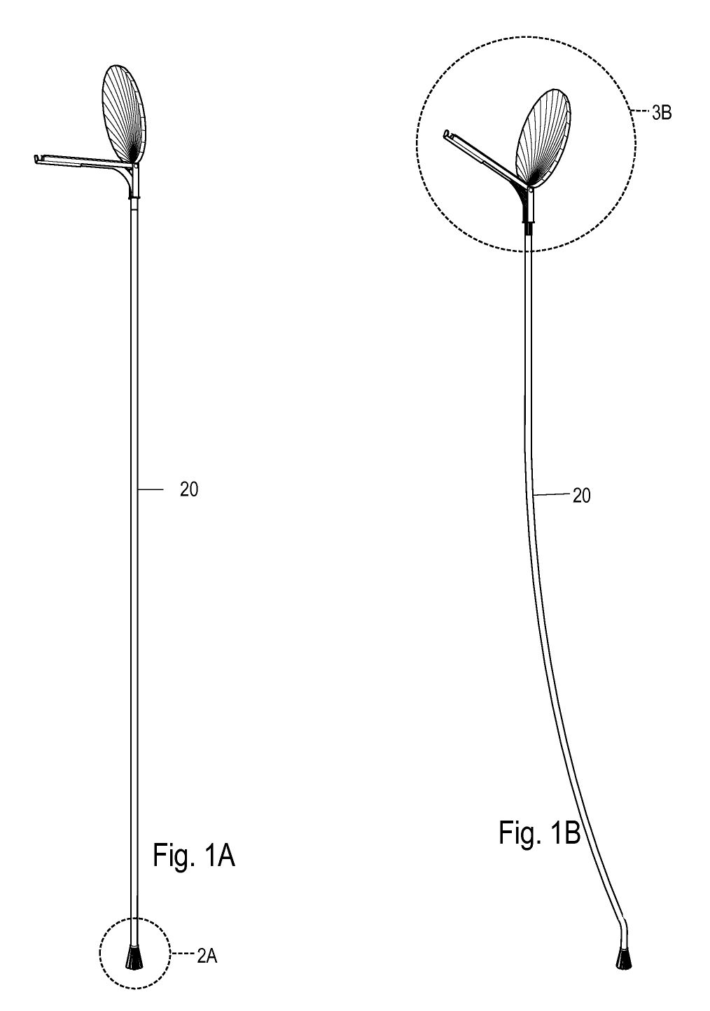

FIG. 1A is a perspective view of an initial position of a first embodiment of the invention.

FIG. 1B is a perspective view of a second position of the embodiment shown in FIG. 1A.

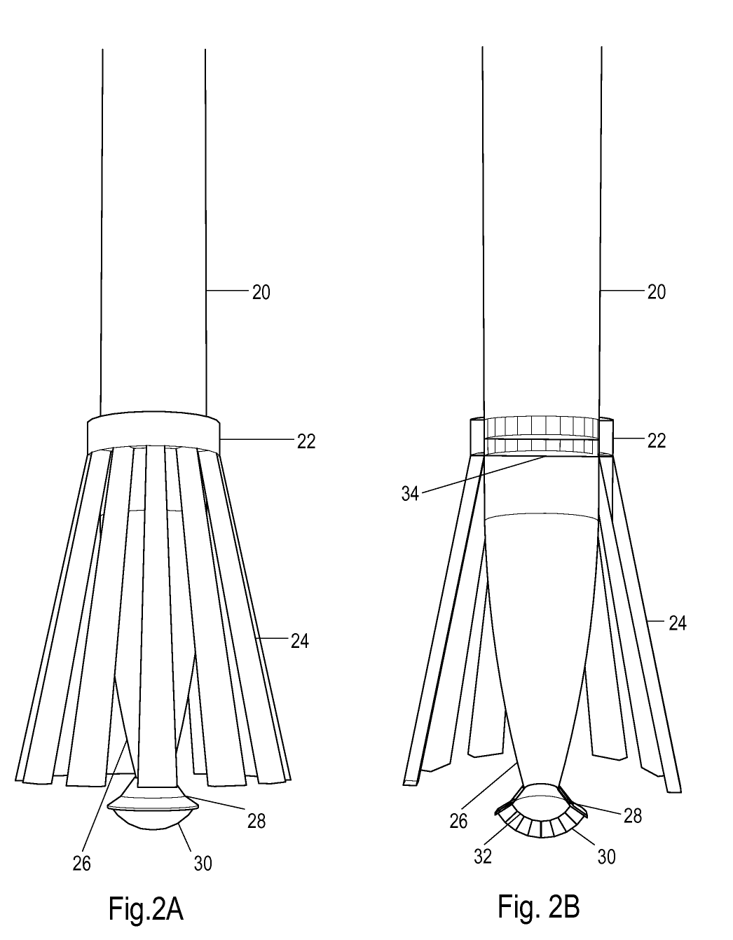

FIG. 2A is a perspective view of the ground based final stage optical concentrator, cavity absorber, and thermal storage unit of a first embodiment.

FIG. 2B is a vertical cross section of FIG. 2A.

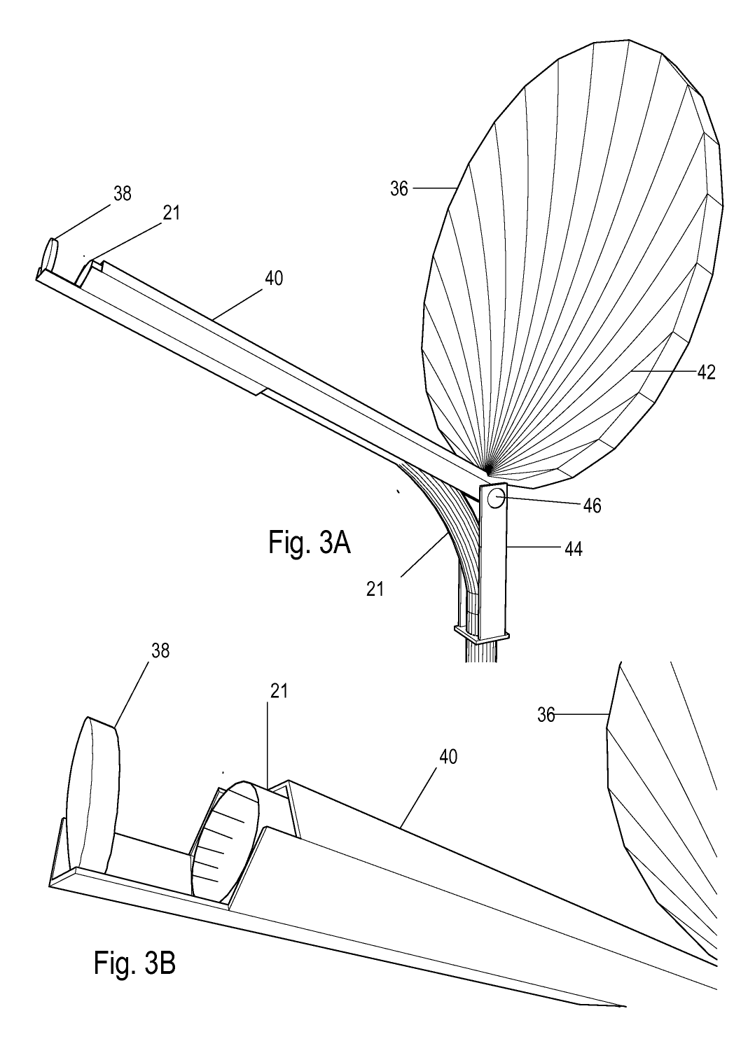

FIG. 3A is a perspective view of the Optical Concentrator and collimator assembly portion of a first embodiment.

FIG. 3B is a close up perspective view of part of FIG. 3A

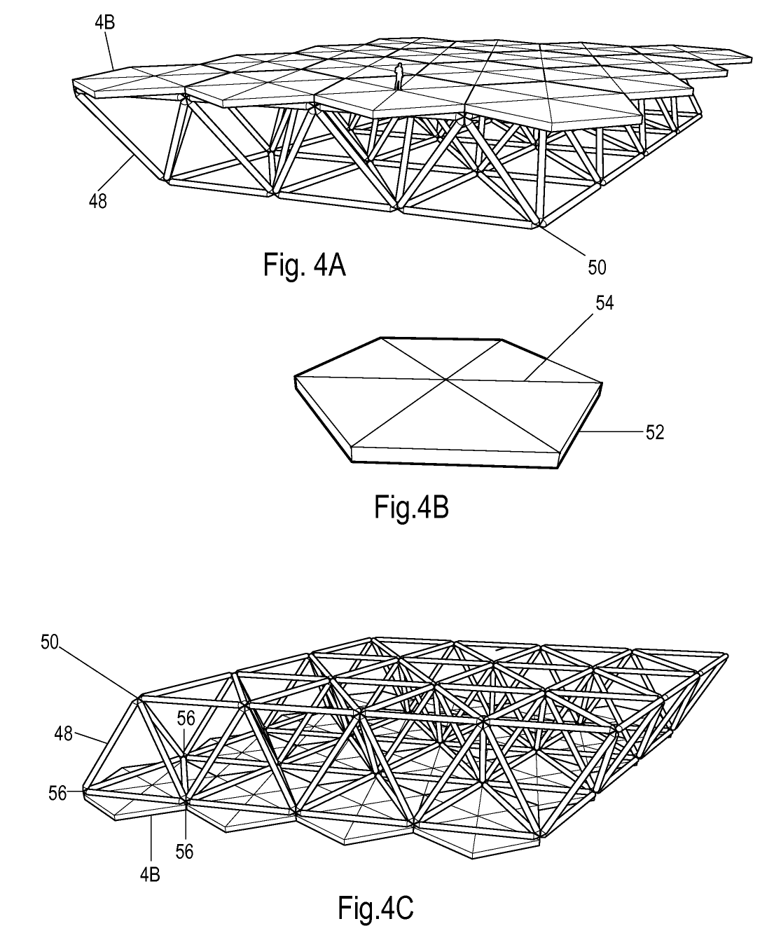

FIG. 4A is a perspective view of the structure of the mirror surface of the Optical Concentrator of a first embodiment.

FIG. 4B is a perspective view of a hexagonal mirror segment of a first embodiment.

FIG. 4C is a perspective view of the back of the structure of the mirror surface of the Optical Concentrator shown in FIG. 4A.

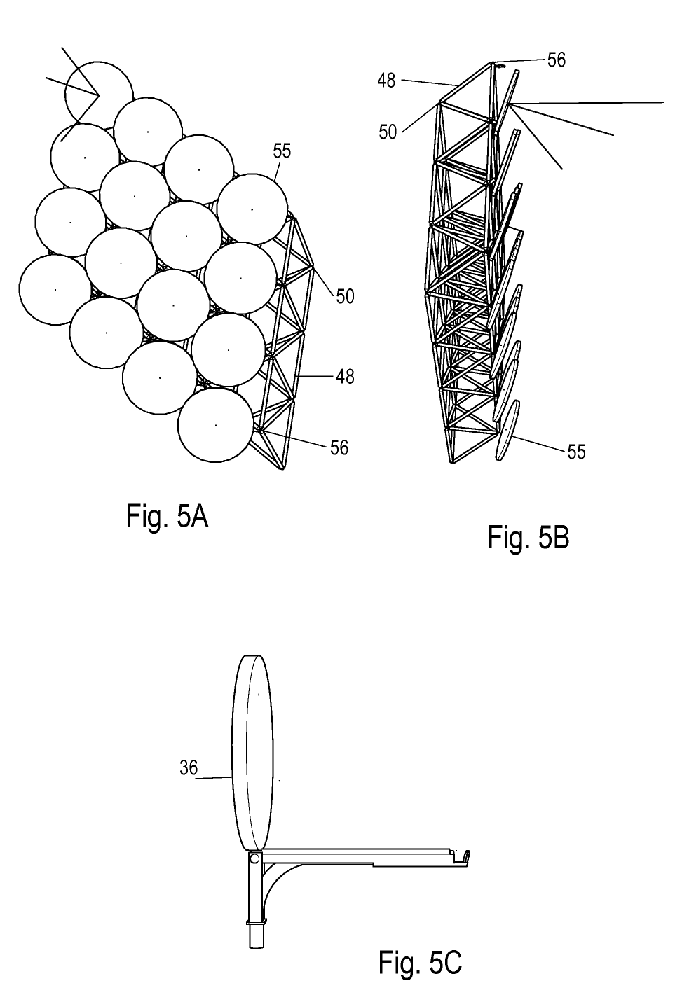

FIG. 5A is a perspective front view of a section of the structure of the mirror surface of a concentrator embodiment using circular mirror segments in a Fresnel fashion.

FIG. 5B is a perspective side view of a section of the structure of the mirror surface of a concentrator embodiment using circular mirror segments in a Fresnel fashion showing the circular mirror tilt.

FIG. 5C is a perspective view of the Optical Concentrator and collimator assembly portion of an embodiment using circular mirror segments in a Fresnel fashion.

FIG. 6 is a schematic of the optical elements of a concentrating solar energy system according to one embodiment.

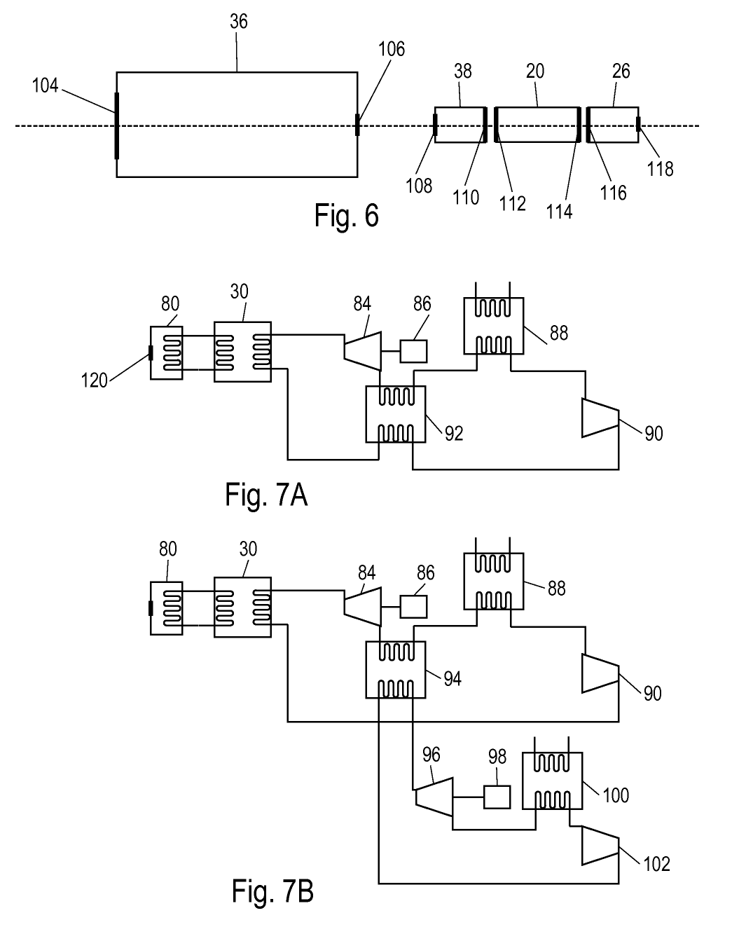

FIG. 7A is a schematic view of the thermal elements of a system for generating electrical power from solar energy according to one embodiment.

FIG. 7B is a schematic view of the thermal elements of a system for generating electrical power from solar energy according to one embodiment.

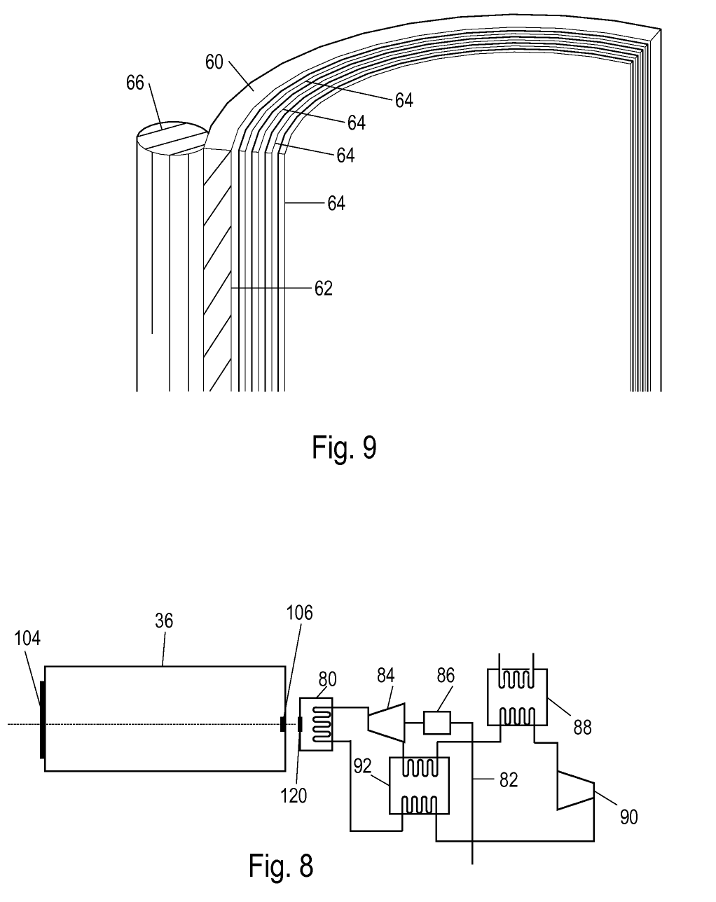

FIG. 8 is a schematic view of the optical and thermal elements of an embodiment that directly couples a receiver to a concentrator.

FIG. 9 is a cross section view of a portion of a light pipe wall of one embodiment.

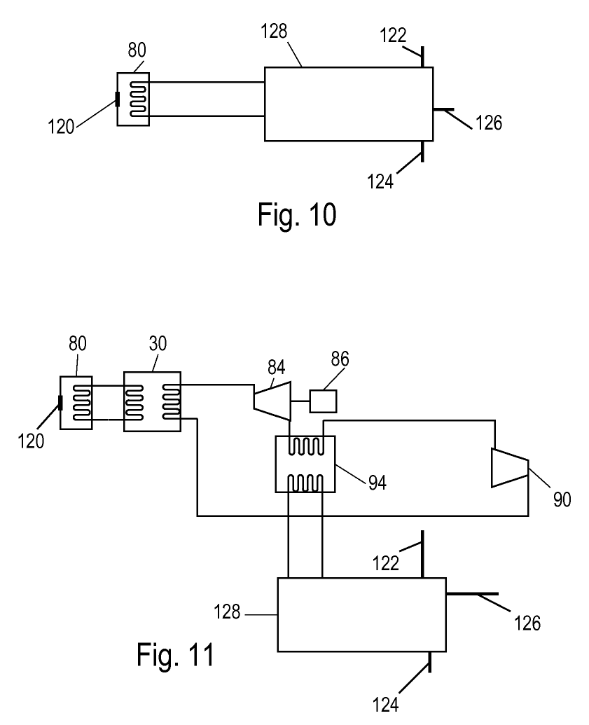

FIG. 10 is a schematic view of a desalination system according to one embodiment

FIG. 11 is a schematic view of a combined electricity and desalination system according to one embodiment.

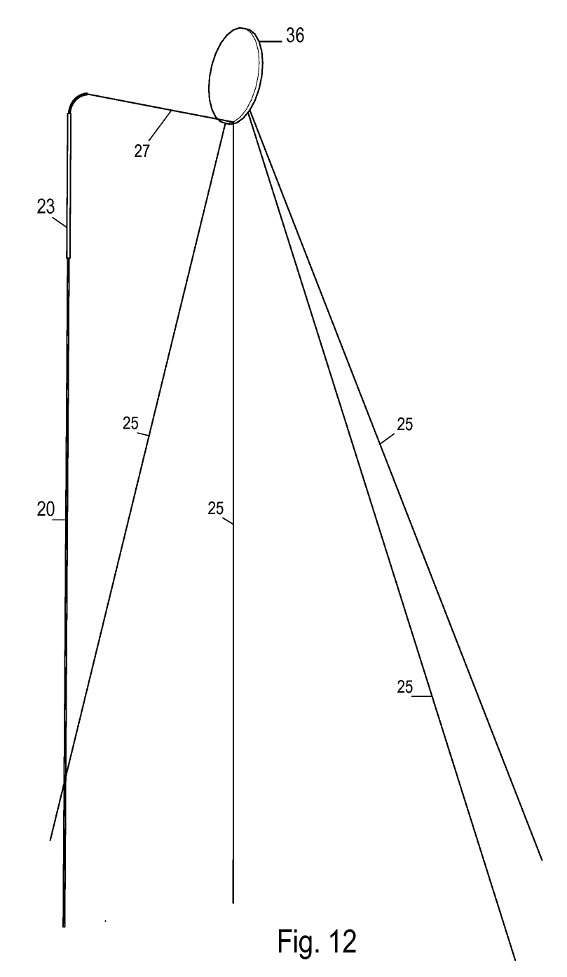

FIG. 12 is a perspective view of an embodiment of a concentrator in the form of a heliostat array attached to a static structure.

DRAWINGS - Reference Numerals

| | | | |
|---|---|---|---|
| 20 | light pipe | 21 | light pipe segment |
| 22 | foundation anchor ring | 23 | buoyancy section |
| 24 | foundation anchor leg | 25 | cable stays |
| 26 | second concentrator | 27 | positioning beam |
| 28 | cavity absorber cover | 30 | thermal storage unit |
| 32 | cavity absorber surface | 34 | transparent membrane |
| 36 | concentrator mirror | 38 | collimator mirror |
| 40 | connecting beam | 42 | mirror shading line |
| 44 | alt-azimuth mount | 46 | alt pivot |
| 48 | truss structure strut | 50 | truss structure joint |
| 52 | mirror segment frame | 54 | mirror segment surface |
| 56 | mirror to truss attachment | | |
| 60 | light pipe wall | 62 | reflective layer |
| 64 | refractive layer | 66 | reinforcement cables |
| 80 | solar receiver | 82 | high voltage transmission line |
| 84 | heat engine | 86 | electricity generator |
| 88 | ambient heat exchanger | 90 | compressor |
| 92 | regenerator heat exchanger | 94 | boiler heat exchanger |
| 96 | steam turbine | 98 | second electricity generator |
| 100 | condensor | 102 | water pump |
| 104 | concentrator input aperture | 106 | concentrator output aperture |
| 108 | collimator input aperture | 110 | collimator output aperture |
| 112 | light pipe input aperture | 114 | light pipe output aperture |
| 116 | second concentrator input | | |
| | aperture | | |
| 118 | second concentrator exit | | |
| | aperture | | |
| 120 | receiver input aperture | | |
| 122 | salt water inlet | 124 | concentrated brine output |
| 126 | fresh water output | 128 | thermal desalination unit |

### DETAILED DESCRIPTION OF THE EXEMPLARY EMBODIMENTS

The description that follows is divided into separate sections with unique headings to help clarify the exposition. The system is first described with respect to schematic diagrams for the optical system and the solar energy conversion system, and then with more detailed perspective drawings, mostly for optical system elements of various embodiments.

### DETAILED DESCRIPTION

### FIG. 6 Optical System

FIG. 6 is a schematic view of the optical elements of a solar concentrator energy system. It consists of a solar concentrator 36 with input aperture 104 and output aperture 106. Solar concentrator 36 is a rigid buoyant structure suspended high in the earth's atmosphere. Input aperture 104 is pointed continuously at the sun. Output aperture 106 is a physical aperture for some non imaging concentrators, but is the focal plane image of the sun for imaging concentrators using reflective or refractive lenses or arrays of lens segments. These lenses will mostly be formed from multiple segments attached to a rigid structure, and can be Fresnel or Fresnel like in construction.

The output aperture 106 of concentrator 36 is directly coupled to the input aperture 108 of collimator 38. The output aperture 110 of collimator 38 is directly coupled to the input aperture 112 of light pipe 20. Collimator 38 can be an imaging, reflective or refractive lens or a non imaging compound parabolic collimator or similar. Compound parabolic non imaging optical elements are well suited to this application as they are easy to couple to light pipes and can be constructed using the same materials and processes.

The size of output aperture 106 is approximately two times the product of the focal length of concentrator 36 and the 4.653 mrad half angle of the Suns radius seen from earth. Collimator 38 is necessary when the focal length of concentrator 36 is short, which may be driven by structural goals. Embodiments that either desire a high concentration ratio, or can accommodate the structural requirements of a longer focal length for concentrator 36 can eliminate the need for collimator 38. Means to couple light from concentrator 36 to light pipe input aperture 112 can therefore be a collimator or an appropriate focal length for concentrator 36 without a collimator.

Light pipe 20 is a flexible, buoyant, thin walled tube structure that stretches from the earth's surface to the concentrator 36 and collimator 38 assemblies high in the earth's atmosphere. Its length is typically in the region of 20 km, and its length to width aspect ratio is in the region of 100 for concentration ratios in the region of 200. Its thin structural skin is airtight, maintains a circular cross section through an internal gage pressure, and is stabilized against high wind and gravity forces. It excludes weather effects like rain, snow, moisture and dust from the transparent gas in the pipe interior. The primary stabilizing force that counteracts wind forces and gravity is buoyancy from hydrogen or helium within high altitude sections of the pipe. Stability is augmented with stiffness in the structural wall, and cable stays when appropriate. Its interior wall surface is highly reflective and provides a low loss transmission path for the concentrated collimated solar energy input through aperture 112.

Second stage concentrator 26 has input aperture 116, directly coupled to light pipe 20 output aperture 114. Concentrator 26 can be an imaging reflective or refractive lens or a non imaging compound parabolic concentrator or similar. Compound parabolic non imaging optical elements are well suited to this application as they are easy to couple to light pipes and can be constructed using the same materials and processes.

### DETAILED DESCRIPTION

### FIG. 7 Solar Energy Conversion System

FIG. 7A is a schematic view of one embodiment of a solar energy conversion system that receives the solar energy delivered by concentrator 26 shown in perspective drawings FIG. 2A and FIG. 2B, and schematic drawing FIG. 6. It consists of receiver 80 with input aperture 120 coupled to the exit aperture 118 of second concentrator 26. Other elements are thermal store 30, heat engine 84, and electricity generator 86. Heat engine 84 might typically be a Brayton cycle gas turbine but other types of expansion engines, including Stirling cycle heat engines are possible

The thermal store 30 decouples the arrival of solar energy from the use of electrical energy, and allows for 24 hour delivery of electricity despite the much shorter duration of daylight. One embodiment of thermal store 30 uses large graphite blocks with integral cooling channels. Graphite has long been used in this form in a variety of nuclear reactor cores. In that application graphite's advantages as a thermal storage medium were secondary to its benefits as a neutron moderator. Graphite has good thermal capacity, and can tolerate higher temperatures than almost any material. It maintains structural integrity at high temperature and can withstand severe thermal cycling. It is abundant and relatively inexpensive.

Other elements of this electricity generation system are ambient cooler heat exchanger 88, compressor 90 and regenerator heat exchanger 92. A common working fluid for high temperature Brayton cycles is helium at high pressure and temperature.

FIG. 7B is a schematic of a second embodiment of a solar energy conversion system that absorbs the solar energy delivered by concentrator 26 from exit aperture 118 shown in FIG. 6 and converts it into electricity. This embodiment is a combined cycle electricity generation system which uses both a Brayton gas turbine cycle, and a Clausius-Rankine water/steam cycle. This embodiment is more efficient at energy conversion but adds additional cost for the steam cycle elements. The additional elements are boiler heat exchanger 94 that is heated with the exhaust gas from heat engine 84, steam turbine 96, second electricity generator 98, condenser heat exchanger 100, and water pump 102. Ambient heat exchanger 88 is probably not needed or can be much simpler for this combined cycle system.

A particular advantage of the use of a combined cycle system with a high temperature concentrating solar system is the improved thermal capacity of sensible heat storage system 82. The thermal storage capacity of thermal store 82 is dependant on the average temperature difference between the high temperature gas delivered to heat engine 84 from high temperature storage and the low temperature gas returned to thermal store 82. For the Brayton cycle with regeneration shown in FIG. 6A this temperature delta is approximately 500 degrees Celsius. For the combined cycle of FIG. 6B this temperature delta approaches 1000 degrees Celsius. This approximately doubles the thermal capacity of thermal store 82, which effectively halves the cost of thermal storage. This comes at the cost of using a thermal fluid that accommodates this large temperature range, which in one embodiment might entail the use of high pressure helium gas as opposed to low pressure liquid fluoride salts.

FIG. 8 is a schematic of a solar concentrator and solar energy conversion system where all solar energy conversion system elements are suspended in the stratosphere with the concentrator and electrical power is transmitted to the earth's surface using buoyant high voltage transmission lines. As with the other embodiments, light is concentrated by buoyant concentrator 36. In this embodiment the output aperture 106 of concentrator 36 is directly coupled to input aperture 120 of receiver 80. The other elements of this solar energy conversion system are similar to those of the embodiment shown in FIG. 7A, with the removal of thermal store 30, and the addition of buoyant high voltage transmission lines 82. Heat engine 84 could be a Stirling engine in this application.

Another embodiment not shown in FIG. 8, but similar in function, employs an array of photovoltaic solar energy convertors electrically connected in series to convert the concentrated solar energy from aperture 106 of concentrator 36 directly into high voltage electricity. The high voltage electrical power is transmitted to the earth's surface using buoyant high voltage transmission lines.

Due to its large mass, it would be difficult to suspend a thermal store in the stratosphere with these embodiments. These embodiments would need a ground based energy storage system to provide continuous electrical power.

### DETAILED DESCRIPTION

### FIGS. 1, 2 Ground Elements

FIGS. 1A and 1B are perspective views of two positions of a solar concentrator energy system of a first embodiment. It consists of the following:

1) A large, buoyant, segmented, reflecting, parabolic, mirror concentrator, and collimator assembly detailed in FIG. 3B.
2) A flexible hollow buoyant light pipe 20.
3) A ground based foundation, anchor, optical concentrator and receiver assembly detailed in FIG. 2A.

FIG. 2A and FIG. 2B show the ground structures of a first embodiment in more detail. Light pipe 20 is attached to anchor ring 22 which is supported by foundation legs 24. Light pipe 20 is a hollow buoyant tube which exerts a considerable vertical upward force on this anchor structure. Transparent membrane 34 is fabricated from polyethylene terephthalate (PET) or other similar transparent film and contains the pressurized gas within the light pipe 20. As is typical for inflated structures the gage pressure is quite low, only a small fraction of an atmosphere. The section of the light pipe at this bottom end is filled with dry air. Buoyancy gas such as hydrogen and Helium are contained within the top section of light pipe 20.

Light pipe 20 connects to the entry aperture on the top of Compound Parabolic Concentrator (CPC) 26 shown in cross section in FIG. 2B. The reflective surface of the upper portion of CPC 26 can be constructed from the same reflective materials as the inner surface of light pipe 20. The bottom portion of CPC 26 is fabricated from heat resistant material with a highly reflective inner surface and has provision for air or water cooling. One embodiment of the exit portion of a CPC is fabricated using carbon composite replica mirror panels. CPC 26 is a small part of the overall system and easily replaced. This allows the concentration factor of the whole system to be adjusted by using different versions of CPC 26. This is flexibility not present in prior art solar concentrating systems where the concentration factor is a fixed feature of the whole system.

In one embodiment a Cavity absorber receiver assembly is attached to the bottom of CPC 26. This is shown as receiver 80 in FIG. 7. The embodiment shown in FIG. 2 blends the receiver and thermal storage functions, and so the receiver is not explicitly diagrammed. The cavity absorber of the receiver assembly consists of thermal insulating top cover 28 and absorber surface 32. Top cover 28 has receiver input aperture 120 which admits the light from the exit aperture of CPC 26 into the cavity absorber. The inner surface of lid 28 is highly reflective, and constructed from high temperature resisting ceramic material such as fire brick.

In one embodiment, absorber surface 32 is directly attached to thermal storage graphite blocks that form thermal store 30. Graphite is particularly suited to high temperature sensible heat thermal storage, as its melting point is extremely high (3652-3697 degrees Celsius) and it maintains its structural integrity close to its melting point. Large graphite blocks with integral cooling channels have long been used in the core of a variety of nuclear reactors. Integrating cooling channels and heat exchangers into the graphite storage blocks eliminates large amounts of high temperature piping and enables higher temperature operation than is feasible with current high temperature piping materials.

As an example to illustrate the scale, 50,000 cubic meters of solid graphite using a thermal delta of 500 degrees Celsius can store over 8 million kilo-Watt hours of thermal energy (28,800,000,000 kJ), and provides sufficient thermal storage capacity to average out the day to night fluctuation in input solar energy for the system described in the first embodiment at mid latitudes. This provides a 24 hour continuous source of thermal energy with considerable flexibility in when during the 24 hour period the stored thermal energy can be withdrawn for use in generating electricity.

The thermal storage capacity required varies with latitude, and the electrical demand curve it is desired to satisfy. The most thermal storage is needed for systems at high latitude. Continuous constant electrical power requires more storage than a system with more electrical output during daylight hours. While thermal storage is a technology that helps make solar energy a practical alternative for all electric power generation, it is also a considerable expense, perhaps half the total system cost, and perhaps the single biggest cost element.

In one embodiment, absorber surface 32 transfers heat to pressurized steam which is used to directly drive Rankine cycle steam turbines. This embodiment is particularly useful when built beside an existing fossil fueled power plant and uses the existing turbines, generators, cooling, and distribution facilities etc. This embodiment acts as a supplement to the existing power plant, reducing its operation to non daylight hours and thus reducing fuel consumption and carbon generation by large percentages. This is potentially a very economic alternative as it re-uses existing infrastructure and avoids the costs of a thermal storage unit.

It should be noted that FIG. 2 illustrates the only part of the system that consumes any land on the earth's surface. The land area needed to house elements found at conventionally fuelled power plants, such as turbines, generators, heat exchangers and electricity distribution equipment which are not shown in FIG. 2 easily fits in the area within the foundation and anchor structure.

### DETAILED DESCRIPTION

### FIGS. 3, 4, 5 High Altitude Elements

FIG. 3A and FIG. 3B are perspective views of the solar concentrator and collimator assembly shown as part of the entire system in FIG. 1. Offset parabolic mirror concentrator 36 is rigidly attached to offset parabolic mirror collimator 38 with beam structure 40. The assembly is neutrally buoyant. Curved shading lines 42 illustrate the offset parabolic curved surface of mirror 36. Beam 40 serves two main purposes. It accurately positions mirrors 36 and 38 at a common optical focus, and it acts as a structural support for light pipe segment 21, enabling its entry aperture to be positioned very close to mirror 38. As the concentrated light reflected off mirror 38 has a wide divergence angle, positioning the light pipe entry close to mirror 38 ensures the capture of most of the collected solar energy.

In one embodiment, mirror 36 is approximately 2.3 km in diameter. The mirror 38 is approximately 180 m in diameter. The light tube 20 is also approximately 180 m in diameter and approximately 20 km long. These dimensions are in the range appropriate for a one Giga Watt (GW), continuous output electricity generation system. The mirrors 36 and 38 are rigid, lightweight, buoyant, gas filled, structures. The light tube 20 is a flexible, buoyant, gas filled, pressurized, structure. The buoyancy gas is either helium or hydrogen. In one embodiment the light tube stores the buoyancy gas within a portion of the light tube to avoid the need for additional buoyancy elements attached external to the light tube. Alt-azimuth mount 44 is used to enable the solar receiver assembly to accurately track the sun while compensating for wind forces on the concentrator and collimator assembly, and motion in the base of the mount 44 attached to the top of light pipe 20. Altitude and azimuth motors within mount 44 are controlled by a closed loop feedback sun tracking system. The structure consisting of concentrator 36, collimator 38 and beam 40 pivots in altitude around altitude pivot 46. The structure pivots in azimuth around the axis of alt azimuth base attached to the top of light pipe 20.

In addition to, or as a replacement for motors in the alt azimuth mount, fan thrusters on the solar concentrator structure can provide the forces that move the concentrator assembly in order to track the sun.

Light pipe segment 21 is flexible and is slightly narrower in diameter than light pipe 20. The end of light pipe segment 21 attached to the mount 44 telescopes within light pipe 20. This allows it to lengthen as the angle of altitude is increased and the amount of bend is reduced, and also to rotate freely within light pipe 20 as the angle of azimuth is adjusted.

In a first embodiment, parabolic concentrator 36 is designed to have 200 times the aperture of parabolic collimator 38 in order to achieve a concentration factor of 200. The concentration factor used in the first embodiment is an engineering design choice constrained by several factors, primarily the reflection efficiency and acceptance angle of the material on the inner surface of the light tube 20, and the light tube aspect ratio, and is not a fixed feature of the invention. As the concentration factor is increased the dispersion angle of the concentrated light beam also increases. This results in more light absorption in the light tube as more reflections occur in the path down the tube to the earth's surface.

The other variable that affects the transmission effectiveness of the light pipe is the length to width ratio, or aspect ratio, of the light pipe. The larger this number is, the higher the energy losses are, as more reflections occur on average as light traverses the light pipe. Numbers for this aspect ratio are usually in the region of 100 for light pipes with efficient reflective surfaces.

So in summary, a combination of the optical design, the concentration factor, the light pipe wall reflectivity, and the light pipe aspect ratio, all influence the overall transmission efficiency of the light pipe.

Very high reflectivity light pipe wall material with reflective efficiency exceeding 99.9% enables embodiments that do not need collimator 38. The acceptance angle of the light pipe then sets the limits for concentrator 36.

FIG. 4A and FIG. 4C show one method for constructing concentrator mirror 36 and collimator mirror 38. FIG. 4A shows a small section of the surface structure of mirror 36, the rest of which is identical in form. It consist of a rigid tetrahedral truss made from struts 48 and connecting nodes 50, which support hexagonal mirror segments shown in FIG. 4B. FIG. 4C shows a back view of FIG. 4A and more clearly illustrates the attachment of mirror segments 4B to the truss at three surface nodes 56. As can be seen from FIG. 4A and FIG. 4C there are nine struts 48 and two nodes 56 for each hexagonal mirror segment.

The struts 48 are light weight hollow tubes. Nodes 50 in one embodiment are spherical and have connectors to attach struts 48. Struts 48 and nodes 50 are standardized elements and mass producible at low cost. The parabolic curvature of the truss is created by slightly increasing the length of the inner layer of struts. The degree of lengthening required is small and is accomplished in one embodiment with spacers. Another embodiment uses linear actuators to adjust strut lengths and more accurately control the structure's shape. This helps compensate for factors that affect the structure's accuracy, such as wind load and thermal expansion and contraction.

Mirrors 36 and 38 are shown in FIG. 3 as approximately 150 meter thick structures. The structural elements shown in FIG. 4A are used to fashion the surface skins of mirrors 36 and 38. The same structural elements without the mirror segments fashion the back skin of mirrors 36 and 38. Clearly the struts and nodes used to fashion the structures for mirror 36 are longer than those used to fashion the structures for mirror 38.

The back and front skins of mirrors 36 and 38 are connected via long struts arranged in the same tetrahedral fashion used to form the skin layers. These long struts are fashioned from the same small truss elements consisting of struts 48 and nodes 50. Thus the overall structure of mirrors 36 and 38 can be considered as a “sandwich” of two stiff thin skins separated by a substantially hollow core with interior tetrahedral and octahedral spaces formed within a tetrahedral truss. This is the same structure used to fashion the mirror skins repeated at a larger scale.

The large interior octahedral and tetrahedral spaces within the tetrahedral truss are filled with like shaped gas bags fashioned from thin impermeable film material such as PET film, and filled with buoyancy gas such as helium or hydrogen maintained at ambient pressure and temperature. For mirror 36, these gas bags will have edge lengths measured in hundreds of meters. The edges are attached to the nodes on the interior struts and the surface skin and provide the buoyancy that supports the overall structure.

In one embodiment, the mirror segments 4B are made from an air tight, lightweight, reflective, pressure tensioned membrane 54 attached to a light rigid air tight frame 52. In one embodiment the membrane is fashioned from aluminized PET film. This relatively fragile material is commonly used in space based inflated structures, and it and similar thin film materials can be used in this application because of the benign “space like” weather free environment in the stratosphere.

The curvature of the mirror 4B surface membrane is controlled by providing reduced air pressure within the frame, thereby stretching the membrane into an approximate spherical curvature. This can be accomplished to a high degree of accuracy because the degree of curvature required is very small. A common measure of the degree of curvature of an optical element is its focal length to aperture ratio, (f/D). For example a 20 meter aperture mirror segment with a focal length of one kilometer has an f/D of 500, which is very large. At such large ratios, spherical surfaces are practically indistinguishable from parabolic surfaces, and are easily formed to high accuracy.

An optical feedback system within the mirror segment measures the mirror depth of curvature on the back of the mirror membrane via an accurate distance measuring device, and adjusts the internal air pressure via a feedback control system to establish and maintain the desired depth of curvature for the mirror segment 4B. In this way a common mirror segment can be manufactured, and then adjusted during operation to a particular curvature depending on its position within the larger mirror assembly. The feedback control system also compensates for manufacturing variability in film thickness etc. It can maintain the desired curvature despite varying conditions such as atmospheric temperature and pressure, segment wall and membrane surface expansion and contraction under heating and cooling cycles, and gas leakage through the surface membrane.

In another embodiment mirror segment 4B is fabricated using very thin carbon composite replica mirror technology that has been developed for large space based optical telescopes. This requires many unique fabrication molds, but does not need active control of the membrane and is more durable. It is a suitably lightweight fabrication technology.

Each mirror segments 4B is attached to the tetrahedral truss at three surface connecting nodes 56 using linear actuators. Each surface node thus acts as an attachment point for three different mirrors and thus three linear actuators. An optical measurement system measures the precise orientation of each mirror segment with respect to the common focus, and the sun. Each mirror segment orientation is then controlled via feedback control adjustment of the length of its three attached actuators, to reflect light to the common focus with great accuracy. This type of system is used in large segmented mirror optical astronomical telescopes to position mirror segments to extremely high accuracy. The mirror segments and linear actuators described in this embodiment are much larger and less accurate than those used in astronomical telescopes, but the positioning method is the same, and pointing accuracy in the order of 0.1 mrad is easily achievable using simple stepper motor linear actuators.

The use of linear actuators to position mirror segments serves additional purposes:

1) The actuators can be adjusted to ensure that light from some mirror segments is not directed from mirror 36 to mirror 38 and is “dumped”. This is useful when it is desired to reduce the amount of light collected.
2) With sophisticated control software the actuators can be used as a fine grained sun tracking mechanism for each mirror segment. This is like the systems used in heliostat arrays, but for a much smaller range of motion. This mechanism can compensate for inaccuracies or slow response in the alt azimuth control of the overall mirror structure 36.

The rigid truss framework forms the stiff and accurate reaction structure that enables the mirror segments to maintain their position with sufficient accuracy. It also provides the framework to hold the ambient pressure, buoyancy gas filled bags. At 20 km altitude, atmospheric pressure is low and substantial volume is needed to provide meaningful lift. The design of both struts and mirror segments emphasizes light weight. For example for an average structural weight of 1 kg/m² of mirror aperture area, a volume of approximately 10 m³ of Helium is needed to provide neutral buoyancy at an altitude of 20 km. A mirror structure 100 meters thick can thus provide lift for an average structural mass of approximately 10 kg/m².

Light weight rigid structures are practical for this application because the structural loads are very light. Wind speed is very low and steady at 20 km, and buoyancy removes much of the stress of supporting gravitational forces. At 20 km altitude, mirrors 36 and 38 are safely in the stratosphere and above all weather in the troposphere, including clouds, moisture, dust, wind, and the jet stream.

The 20 km height of the mirrors in the atmosphere is illustrative. The actual height of individual systems may vary with geographic location. The height of the boundary between the troposphere and the stratosphere varies with latitude, season of the year and local weather conditions. The boundary height is generally lower at higher latitudes and in the winter.

FIG. 5 Illustrates another embodiment similar to FIG. 4, but using circular mirror segments 55 arranged in a Fresnel fashion. The supporting structure 36 is a flat thin circular cylinder and the attached circular mirror segments 55 are each mounted tilted from structure 36 to reflect light to a common focus. The structural elements, struts 48, nodes 50 and 56, and linear actuators are identical to those in embodiment shown in FIG. 4. The method of construction of circular mirror segments 55 is similar to that described for hexagonal mirror segments 4B.

Circular segments are easier to fabricate than hexagonal segments, but they cover less area due to their non space filling shape. The Fresnel approach simplifies the supporting structure, but is slightly less efficient due to shading or extra spacing requiring a larger structure with more mirrors and struts than the hexagonal segments approach.

### DETAILED DESCRIPTION

### FIG. 9 Light Pipe

FIG. 9 is a perspective cut-out view that illustrates the structure of a portion of the wall of the light pipe tube 20. The first embodiment uses a fiber reinforced fabric as the main wall structural element 60. Structural fabrics have long been used to construct large inflatable structures. Among the most widely used materials are polyester fabric laminated or coated with polyvinyl chloride (PVC), and woven fiberglass coated with polytetrafluoroethylene (PTFE). The light tube is an inflated structure filled with a gases that provide buoyancy and light transparency. Dry air, nitrogen, and either helium or hydrogen are some viable options. Several transparent membranes 34 fabricated from polyethylene terephthalate (PET) or other similar transparent film, like that depicted in FIG. 2B are positioned at points along the length of the light pipe. They contain the pressurization of the light pipe 20 and act as separators between buoyancy gas filled regions and air filled regions.

In one embodiment, vertically oriented steel cables 66 attached to the outer side of the structural fabric carry the vertical pre-tension load provided by the buoyancy of the light pipe. Cables from other materials or stronger fabrics without external reinforcement are viable alternatives.

The vertical force acts to stabilize gravity forces and the horizontal displacement of the light pipe caused by wind forces. These horizontal forces are very large, especially at the higher altitudes of the jet stream. In effect this section of the light pipe behaves approximately like a hanging catenary cable.

The diameter of the steel cables can be reduced as the tension load diminishes with height in buoyant regions of the light pipe. Ultimately, at the top of the light pipe the tension is close to zero.

At the bottom section of the light pipe 20 that connects to the second concentrator 26 and anchor structure it is beneficial to add additional structural reinforcement in a manner that enhances the stiffness of the light pipe. In one embodiment this is done using steel cable hoop reinforcement attached to the vertical steel reinforcement. This section of the light pipe 20 behaves more like a cantilever beam attached to the foundation structure, than the catenary cable of the upper portion of light pipe 20. This stiffness helps to keep the light pipe vertical at the CPC entry which optically aligns the light pipe with the CPC without resort to complex mechanical methods. This takes advantage of the light pipes ability to accommodate gradual bends while still maintaining high transmission efficiency.

A reflective layer is attached to the inner surface of structural fabric wall 62. In one embodiment this is a layer of aluminized PET film. Mounted to the inner wall 62 is a refracting layer 64. In one embodiment layer 64 is made of prismatic transparent reflecting film, as used in lighting system light tubes. One such commercially available material is 3M Optical Lighting Film™. This film uses the principal of total internal reflection as taught by Whitehead in U.S. Pat. No. 4,260,220, “Prism light guide having surfaces which are in octature” and can be 99% efficient in reflecting light within the acceptance angle. A portion of the small amount of light that leaks through the prismatic film 64 is reflected by the metallic reflective film 62, further enhancing overall reflection efficiency.

Another embodiment uses multiple layers of transparent film such as PET film for layer 64 and exploits the principle of multi layer reflectance as taught by Waymouth in U.S. Pat. No. 4,895,420, “High reflectance Light Guide”. This approach also only works for a limited acceptance angle. These various techniques, exploiting both reflection from layer 62 and refraction within layer 64 can exceed 99.5% overall reflectivity.

### DETAILED DESCRIPTION

### FIGS. 10, 11 Process Heat Thermal Desalination Plants

FIG. 10 shows a schematic view of a solar process heat desalination plant. Large scale desalination plants are becoming increasingly common. The largest plants burn fuel to produce steam for process heat. This steam is used as the primary energy input into the desalination process. Two common thermal desalination techniques are flash evaporation, and multi effect distillation.

In FIG. 10, aperture 120 in receiver 80 receives solar energy from the exit aperture of a solar concentration system, such as that illustrated in FIG. 6. Receiver 80 heats cold water provided by desalination plant 128 as the working fluid and returns it as steam. Desalination plant 128 receives brackish or salt water via inlet 122 and produces fresh water, a portion of which provides the water for the receiver and the majority of which is provided from outlet 126. Concentrated brine is output from outlet 124.

In conventional thermal desalination plants, the major cost is the fuel to operate the plant, which also puts carbon dioxide into the atmosphere. In this embodiment, all the solar energy is being utilized for desalination. There is no thermal storage or electricity generation, which reduces the capital cost. There is no fuel cost and no carbon dioxide emissions. The plant can be positioned where the salt or brackish water supply is located. Clean water can be provided at lower cost than current systems without putting carbon dioxide into the atmosphere.

FIG. 11 shows a schematic view of a combined electricity generation and thermal desalination plant. This uses heat that would otherwise be rejected to the environment as process heat for desalination. Receiver 80 receives solar energy through aperture 120 and transfers heat via a working fluid to thermal store 30. A second working fluid transfers heat from thermal store 30 to heat engine 84 which expands it producing work which drives generator 86 producing electricity. Hot exhaust from heat engine 84 is passed through boiler 94, producing steam for desalination plant 128. Desalination plant 128 accepts salt or brackish water through inlet 122 and produces fresh water through outlet 126, and concentrated brine discharge through outlet 124.

### DETAILED DESCRIPTION

### FIG. 12 Heliostat Array

FIG. 12 is a perspective view illustrating an embodiment using a heliostat array. Concentrator 36 is a static buoyant structure held in place with cable stays 25. Each individual mirror segment attached to concentrator 36 tracks the sun and positions itself to reflect sunlight to a common focus at the entry aperture of light pipe 20. Beam 27 helps maintain the position of the entry aperture. Buoyancy collar 23 provides buoyancy for embodiments where the light pipe diameter is too small to provide sufficient internal buoyancy. The embodiment shown has a high concentration factor and hence a narrow light pipe, and does not need a collimator at the light pipe entry aperture. For embodiments with a lower concentration factor and larger diameter light pipe where a short focal length is desired, a Compound Parabolic Collimator is well suited to these heliostat embodiments, as opposed to the parabolic mirror collimator shown in the first embodiment.

### OPERATION

### FIGS. 1, 2, 3, 4, 5, 6, 7

FIG. 1A and FIG. 1B shows two operational positions of a first embodiment. FIG. 1A shows the solar concentrator assembly pointing at the horizon, or approximately 0 degrees of altitude as it is at dawn and dusk. The light pipe 20 is shown straight and vertical, as is the case when no wind is blowing.

As the sun rises, light is reflected from concentrator mirror 36 onto collimating mirror 38, and then reflected from collimator mirror 38 to the entrance aperture of light pipe segment 21. As the light reflects off mirror 36 and 38 and is concentrated, its dispersion half angle increases from the 4.653 mrad of the incident sunlight to a larger number approaching 60 mrad at the entrance to light pipe segment 21. The light then travels down light pipe segment 21 reflecting occasionally off the reflective walls and around the bend in the pipe at the alt azimuth mount 44 that connects to the main light pipe 20. Light then travels down light pipe 20 reflecting occasionally off the reflective wall which has gradual bends as the light pipe adjusts to the force of the wind it experiences in the troposphere.

At the bottom of light pipe 20 at ground level the light passes through the final optical concentrator element CPC 26, exiting the optical system and entering the thermal system.

In one embodiment of a solar energy conversion system shown in FIG. 7A receiver 80 accepts the concentrated solar energy through input aperture 120, absorbs it, and transfers it as thermal energy to the working fluid. The working fluid is used to transfer the thermal energy to thermal store 30 via a closed loop. A second closed loop transfers heat from thermal store 30 to a high pressure, high temperature working fluid. This gas is expanded through heat engine 84, converting the heat to mechanical work. This work is used to drive electricity generator 86, which converts the mechanical work to electricity.

Exhaust gas from heat engine 84 passes through regenerator 92, transferring heat to the cooler high pressure gas output from compressor 90. After exiting regenerator 92, the low pressure, low temperature gas passes through ambient cooler heat exchanger 88, where it is further cooled before entering compressor 90. High pressure pre-heated gas from the regenerator 92 enters thermal store 30, completing the thermal circuit.

In the combined cycle solar energy conversion system embodiment shown in FIG. 7B, the exhaust gas from heat engine 84 is used to heat high pressure, low temperature water in boiler heat exchanger 94. This superheated water then expands as steam through steam turbine 96, converting the heat to mechanical work. This work is used to drive electricity generator 98, which converts the mechanical work to electricity. Condensor heat exchanger 100 cools turbine 96 exhaust gas which is then pressurized by water pump 102. Ambient heat exchanger 88 can be much simpler for this combined cycle system.

As the day progresses, the solar concentrator and collimator tracks the sun, rotating the entire mirror and alt-azimuth mount structure in azimuth and tilting the structural axis (which is parallel to beam 40) in azimuth. The motion is driven by motors in the alt-azimuth mount 44 which are controlled by a sun tracking control system. As is shown in FIG. 1B, the light pipe 20 bends in response to winds in the lower atmosphere. The upper approximately 5 km portion of light pipe 20 is always kept vertical. There are no significant winds acting on this section and it is filled with buoyancy gas. This minimizes the adjustments necessary to maintain sun tracking as the base of the alt-azimuth mount moves with light pipe 20.

### ADVANTAGES

Unlike prior art concentrating solar energy systems, the geographic location of these embodiments is not constrained to desert areas. This is of particular benefit to normally cloudy mid latitude locations where most large urban areas are located.

The combination of geographic flexibility and power generation without the need for any fuel provides a secure and clean energy system.

Power in the form of concentrated solar energy or electricity can be provided at any point on the earth's surface, where the definition of surface includes the entire surface, including all land and oceans. Offshore platforms could be a particularly convenient in some locations. Concentrated direct solar energy and or electricity could be provided near mines, allowing convenient high temperature processing without transportation of bulk ores.

The very small amount of land area needed means that systems can be located very near existing power plants, or existing transmission and distribution networks, which reduces or eliminates the need for new electricity transmission infrastructure.

With the thermal storage described in the embodiments a reliable and flexible power generation system that can continuously supply all energy requirements without augmentation with other power generation sources, as is required with prior art solar power and other alternative energy systems.

Energy systems that do not put carbon dioxide into the atmosphere are highly desirable. Currently all alternative energy systems suffer from major problems:

1) They are very costly to build
2) They are unreliable providers of electricity due to intermittent weather affects, and so need backup generation using alternate energy sources such as natural gas.
3) They need large additional energy storage and transmission infrastructure investments.
4) The energy is located far from users, again requiring large transmission infrastructure investments.
5) They require large areas of land which increases their environmental impact and limits their use to areas where both energy and land are available.

This new system has the benefit of not producing carbon dioxide and has none of these problems. The bottom line is clean secure energy can be provided at much lower cost and minimal environmental impact.

The benefits of suspending a collector in the stratosphere are the reliability of the energy source, the higher incident energy density, and the benign stable calm low wind weather free environment. These benefits come at the price of lower atmospheric density, which means less buoyant lift and a consequent need for a very lightweight structure. This complicates the use of heavy energy absorbing and/or power conversion equipment at the collector in the stratosphere, and explains the benefit of embodiments using a light pipe to transport the light energy directly to the earth's surface, without conversion.

It is envisaged that the large buoyant optical structures, particularly mirror structures 36 and 38 will be assembled at one or more centralized factory locations in a highly automated fashion. The assembled structures will then be raised by their own buoyancy into the stratosphere and “flown” to their destination anywhere on the planet. There they will be connected to the light pipe and ground based elements. This manufacturing method greatly reduces cost, improves quality, and speeds construction. It is envisaged that when production is mature, complete utility size electricity generating facilities could be operational in less than a year from breaking ground. This compares with current technologies which require three to five or more years to construct.

Although the present invention has been described in terms of a first embodiment, it will be appreciated that various modifications and alterations might be made by those skilled in the art without departing from the spirit and scope of the invention. Though the first embodiment is described using offset parabolic mirror arrays for the concentrator and collimator elements, other forms of concentrators and collimators using a myriad of different optical geometries are possible. Also refractive optics elements such as lightweight arrays of thin prismatic elements, or inflatable reflective or refractive optical elements are also possible.

All that is required of the light tube is a sound gas tight structure filled with transparent gas, and having a high inner surface reflective efficiency, both of which can be met with many alternative materials and structural approaches. As described in the specification, there are various structural techniques to stabilize the light pipe against atmospheric wind forces including:
a) pre-tensioned hanging cables using excess buoyancy to provide the tensioning force,
b) cable stays,
c) rigid light pipe walls.

Each of these techniques or a combination of some or all is possible.

The invention should therefore be measured in terms of the claims which follow.

What is claimed is:

1. A method of providing concentrated solar energy for use at any location on the earth's surface irrespective of weather, comprising:
a) providing a light weight solar concentrator,
b) providing a rigid buoyant structure supporting the solar concentrator,
c) suspending the buoyant structure high in the earth's atmosphere,
d) pointing the concentrator continuously at the sun, collecting solar energy,
e) concentrating solar energy,
f) providing a light pipe coupled to said collimator high in the earth's atmosphere at one end and connected to the earths surface at the other end,
g) providing means to couple said light pipe to said solar concentrator,
h) transmitting the concentrated solar energy from the solar concentrator, through said light pipe to the earth's surface,
whereby concentrated solar energy can be provided for use at any location on the earth's surface, such use including generation of electricity via thermal or photovoltaic means and, direct and indirect process heat.

2. The method of claim 1, further comprising:
a) providing a solar receiver optically coupled to said light pipe,
b) receiving said concentrated solar energy,
c) heating a first working fluid in said receiver,
d) providing a thermal storage element thermally coupled to said
receiver,
e) storing heat in said thermal storage element by transferring heat from said first working fluid,
f) heating a second working fluid from heat stored in said thermal element when needed,
g) providing a plant utilizing process heat, thermally coupled to said thermal storage element,
h) transferring heat from said second working fluid to said plant,
i) using said heat for thermal processing,
whereby water can be desalinated, or fuel manufactured continuously at any location on the earth's surface.

3. The method of claim 1, further comprising:
a) providing a solar receiver optically coupled to said light pipe,
b) receiving said concentrated solar energy,
c) heating a working fluid in said receiver,
d) providing a plant utilizing process heat, thermally coupled to said thermal storage element,
e) transferring heat from said working fluid to said process heat
plant,
f) using said heat for thermal processing,
whereby water can be desalinated, or fuel manufactured during daylight at any location on the earth's surface.

4. The method of claim 1, wherein:
the light pipe is a buoyant, pressurized, thin walled tube structure with an air tight structural skin, transparent gas interior, and a highly reflective inner wall surface.

5. The method of claim 4, wherein:
the highly reflective inner wall surface uses prismatic film, making the structure a prismatic light guide.

6. The method of claim 4, wherein:
the highly reflective inner wall surface uses multiple layers of transparent film separated by thin layers containing the interior transparent gas contained within the light pipe, making the structure a high reflectance light guide.

7. The method of claim 1, wherein:
the rigid buoyant structure remains stationary with respect to the earth's surface and the individual mirror elements forming the concentrator each individually move and track the sun and reflect sunlight to a common focus which is also stationary with respect to the earths surface, thus pointing the concentrator to track the sun and coupling the concentrated sunlight to said light pipe,
whereby concentrated solar energy can be provided for use at any location on the earth's surface, using a high altitude heliostat array.

8. The method of claim 1, wherein:
the rigid buoyant structure moves with respect to the earth's surface tracking the suns movement, and the individual mirror elements forming the concentrator are fixed to the structure and reflect sunlight to a common focus which is fixed to said moving structure, thus pointing the concentrator to track the sun and coupling the concentrated sunlight to said light pipe,
whereby concentrated solar energy can be provided for use at any location on the earth's surface, using a high altitude moving multi segment mirror.

9. The method of claim 1, further comprising:
a) providing a solar receiver optically coupled to said light pipe,
b) receiving said concentrated solar energy,
c) heating a working fluid in said receiver,
d) providing a heat engine thermally coupled to said receiver,
e) expanding said working fluid to drive said heat engine,
f) providing a generator mechanically coupled to said heat engine,
g) driving said generator to produce electricity,
h) Providing a boiler thermally coupled to said working fluid exhaust of said thermal engine,
i) heating a second working fluid in said boiler with said exhaust working fluid,
j) providing a plant utilizing process heat, thermally coupled to said boiler,
k) transferring heat from said second working fluid to said process heat plant,
l) using said heat for thermal processing,
whereby water can be desalinated, or fuel manufactured and electricity generated during daylight at any location on the earth's surface.

10. The method of claim 1, further comprising:
a) providing a solar receiver optically coupled to said light pipe,
b) receiving said concentrated solar energy,
c) heating a working fluid in said receiver,
d) providing a thermal storage element thermally coupled to said receiver,
e) transferring heat to said thermal storage element using said working fluid,
f) transferring heat when needed from said thermal storage element to a second working fluid,
g) providing a heat engine thermally coupled to said thermal storage element,
h) expanding said second working fluid to drive said heat engine,
i) providing a generator mechanically coupled to said heat engine,
j) driving said generator to produce electricity when needed,
k) providing a boiler thermally coupled to said second working fluid exhaust of said thermal engine,
l) heating a third working fluid in said boiler with said exhaust working fluid,
m) providing a plant utilizing process heat, thermally coupled to said boiler,
n) transferring heat from said third working fluid to said process heat plant,
o) using said heat for thermal processing,
whereby water can be desalinated, or fuel manufactured and electricity generated continuously at any location on the earth's surface.

11. A system capable of concentrating solar energy at any location on the earth's surface irrespective of weather, the system comprising:
a) a light weight solar concentrator,
b) a light weight, rigid, buoyant, structure connected to and supporting the solar concentrator, suspended high in the earth's atmosphere,
c) means for said concentrator to track the sun, such means including steerable mirrors, and a steerable structure,
d) a light pipe optically coupled to said concentrator high in the earth's atmosphere at one end and connected to the earths surface at the other end, said light pipe capable of transmitting the concentrated solar energy received from said solar concentrator, through said light pipe to the earth's surface,
whereby concentrated solar energy can be provided for use at any location on the earth's surface, such use including generation of electricity via thermal or photovoltaic means and, direct and indirect process heat.

12. The system of claim 11, further comprising:
a) a solar receiver optically coupled to said light pipe, which receives said concentrated solar energy, and heats a first working fluid in said receiver,
b) a thermal storage element thermally coupled to said receiver, which stores heat in said thermal storage element by transferring heat from said first working fluid, and heats a second working fluid from heat stored in said thermal storage element when needed,
c) a plant utilizing process heat, thermally coupled to said thermal storage element, which transfers heat from said second working fluid to said plant, and uses said heat for thermal processing,
whereby water can be desalinated, or fuel manufactured continuously at any location on the earth's surface.

13. The system of claim 11, further comprising:
a) a solar receiver optically coupled to said light pipe, which receives said concentrated solar energy, and heats a working fluid in said receiver,
b) a plant utilizing process heat, thermally coupled to said thermal storage element, which transfers heat from said working fluid to said plant, and uses said heat for thermal processing,
whereby water can be desalinated, or fuel manufactured during daylight at any location on the earth's surface.

14. The system of claim 11, wherein:
the light pipe is a buoyant, pressurized, thin walled tube structure with an air tight structural skin, transparent gas interior, and a highly reflective inner wall surface.

15. The system of claim 14, wherein:
the highly reflective inner wall surface uses prismatic film, making the structure a prismatic light guide.

16. The system of claim 14, wherein:
the highly reflective inner wall surface uses multiple layers of transparent film separated by thin layers containing the interior transparent gas contained within the light pipe, making the structure a high reflectance light guide.

17. The system of claim 11, wherein:
the rigid buoyant structure remains stationary with respect to the earth's surface and the individual mirror elements forming the concentrator each individually move and track the sun and reflect sunlight to a common focus which is also stationary with respect to the earths surface, thus pointing the concentrator to track the sun and coupling the concentrated sunlight to said light pipe,
whereby concentrated solar energy can be provided for use at any location on the earth's surface, using a high altitude heliostat array.

18. The system of claim 11, wherein:
the rigid buoyant structure moves with respect to the earth's surface tracking the suns movement, and the individual mirror elements forming the concentrator are fixed to the structure and reflect sunlight to a common focus which is fixed to said moving structure, thus pointing the concentrator to track the sun and coupling the concentrated sunlight to said light pipe,
whereby concentrated solar energy can be provided for use at any location on the earth's surface, using a high altitude moving multi segment mirror.

19. The system of claim 11, further comprising:
a) a solar receiver optically coupled to said light pipe, which receives said concentrated solar energy, and heats a working fluid in said receiver,
b) a heat engine thermally coupled to said receiver, which expands said working fluid to drive said heat engine,
c) a generator mechanically coupled to said heat engine which drives said generator to produce electricity,
d) a boiler thermally coupled to said heat engine's exhaust, which heats a second working fluid in said boiler with said exhaust working fluid,
e) a plant thermally coupled to said boiler, which receives heat from said second working fluid, and uses said heat for thermal processing,
whereby water can be desalinated, or fuel manufactured and electricity generated during daylight at any location on the earth's surface.

20. The system of claim 11, further comprising:
a) a solar receiver optically coupled to said light pipe, which receives said concentrated solar energy, and heats a working fluid in said receiver,
b) a thermal storage element thermally coupled to said receiver, to which heat is transferred using said working fluid, and from which heat is transferred when needed to a second working fluid,
c) a heat engine thermally coupled to said thermal storage element, which expands said second working fluid to drive said heat engine,
d) a generator mechanically coupled to said heat engine, which drives said generator to produce electricity when needed,
e) a boiler thermally coupled to said second working fluid exhaust of said thermal engine, which heats a third working fluid with said exhaust working fluid,
f) a plant, thermally coupled to said boiler, which receives heat from said third working fluid, and uses said heat for thermal processing,
whereby water can be desalinated, or fuel manufactured and electricity generated continuously at any location on the earth's surface.
